(19) United States
(12) Patent Application Publication
(10) Pub. No.: US 2011/0250349 A1
(43) Pub. Date: Oct. 13, 2011

(54) METHOD AND SEALANT FOR SEALING AIR FILTER LEAKS

(76) Inventor: R. Vijayakumar, Liverpool, NY (US)

(21) Appl. No.: 12/759,018

(22) Filed: Apr. 13, 2010

(51) Int. Cl. B32B 43/00; C09K 3/12

(52) U.S. Cl. 427/140; 106/33

(57) ABSTRACT

The present invention relates generally to a method and device for composition air filter leaks, and, more particularly, to a method and sealant for sealing high efficiency air filter leaks without blocking significant parts of the filter.

### RELATED APPLICATION

This application relates to Applicant's co-pending U.S. patent application Ser. No. 12/355,660 filed Jan. 16, 2009, which claims priority to U.S. Provisional Application Ser. No. 61/021,749, filed on Jan. 17, 2008, both of which are hereby incorporated by reference herein in their entireties.

### BACKGROUND OF THE INVENTION

1. Field of Invention

The present invention relates generally to a method and composition for sealing air filter leaks, and, more particularly, to a method and sealant for sealing high efficiency air filter leaks without blocking significant parts of the filter.

2. Description of Prior Art

High efficiency air filters, commonly called HEPA or ULPA air filters, are widely used to produce particle free air in a variety of industrial and commercial facilities. The activity and processes taking place within many of these facilities will be adversely affected by contamination from particles in the airflow. These particles can include, for example, contaminants that adversely affect drugs produced in a pharmaceutical plant, cause a defect in a semiconductor wafer, or act as an undesirable foreign body in a drug compounded in a pharmacy.

Particle contamination mainly occurs due to leaks in filters that allow unfiltered air to pass through the filter, and affect the cleanliness of the facility. For this reason, leaks in HEPA and ULPA air filters are not acceptable, and hence are conventionally repaired or patched as shown in FIG. 1 (discussed below). Leaks in filters usually occur due to pinhole size blemishes caused during filter manufacturing or during use. Guidelines for acceptable repairing practice are given in most of the prevailing national and international standards (as should be appreciated by those skilled in the art, and need not be repeated herein).

As seen in FIGS. 1a-b, HEPA and ULPA air filters 10 are constructed by pleating filter media 100 into an accordion style construction. FIG. 1a shows a schematic face view of a cross section of an air filter 10 illustrating accordion style pleated air filter media 100 common to HEPA and ULPA air filters. The pleat shape and size as well as the method of holding the filter media 100 in place vary to accommodate the end use. The media 100 used in most HEPA and ULPA filters are made from micro fiberglass with fiber diameters as small as 200 nm and lengths of a few millimeters. These fibers are held together in a thin web by a small quantity of polymeric binder. The most common polymeric binder used for such media are thermosetting or thermoplastic acrylic ester latex polymers with other additives such as water repellants that are proprietary to the manufacturer of these media. These webs are about 0.5 mm thick and are usually made on a paper machine from a slurry of fibers and to which the polymeric binder is added either in the slurry or separately.

Typical fibrous structures of such filter media 100 and its multiple fiber layers are shown in magnified (scanning electron microscope (“SEM”)) views in FIGS. 2a-b. Although each layer of the media appears to be inhomogeneous, a typical media is made up of several hundred layers of fibers. Thus, only a true blemish or pinhole will result in a leak that will require repair.

FIG. 1b is an expanded view of a portion of the air filter 10 as shown in FIG. 1a. FIG. 1b illustrates a section which contains a suspected leak that needs to be patched. As shown in FIG. 1b, current repair practice uses polymeric sealing or caulking compounds 120 to seal/patch the area around a suspected leak 110. Conventional sealing compounds 120 include silicone and silicone based caulks, poly urethane, and other similar caulking compounds. Most of the time, since leaks are repaired in the field on installed filters, a caulk-like consistency is required for the sealing compound to permit repairs overhead in ceilings, for example. In cases where it is practical, such as in a factory, a nearly liquid sealant is poured into the space between the folded filter media near the location of the leak. This blocking technique, while effective in sealing the leak 110, blocks significant parts of the filter 10 thereby reducing the filter's effectiveness (dark patch 120). Further, the application of such sealing or caulking compounds 120 to seal leaks 110 in filters 10 already installed in ceilings, for example, often proves to be a cumbersome and inefficient procedure.

### SUMMARY OF THE INVENTION

It is therefore a principal object and advantage of the present invention to at least partially seal (and preferably completely seal) air filter leaks without blocking significant parts of the filter, which would result in a reduction in the filter's effectiveness.

In accordance with the foregoing object and advantage, an embodiment of the present invention provides a sealant or patch that takes advantage of the fibrous nature of air filter media, and allows for active filtration through and around the leak. As compared with conventional sealing technology, the sealant does not completely seal or block a significant part of the filter (i.e., it is porous), thus allowing for this active filtration. The present invention also provides a method of sealing air filter leaks with the porous patch.

In accordance with an embodiment of the present invention, a sealant is provided which includes a micro fiber glass, and a propellant. The glass fibers can include, but are not limited to, borosilicate fibers. The propellant can include, but is not limited to, a compressed gas selected from the group consisting of air, nitrogen, and a non-highly flammable gas (as should be appreciated by those skilled in the art). The sealant can also include a solvent including, but not limited to, water, alcohol, and a mineral spirit. The sealant can be pressurized with a propellant within a housing including, but not limited to, an aerosol can. The mixture can optionally contain less than 10% micro fiber glass.

In accordance with an embodiment of the present invention, a method of sealing a leak in a portion of an air filter is provided. The method includes, but is not limited to, applying a sealant comprising a micro fiber glass to the portion of the air filter which includes the leak, and allowing the sealant to cure. The sealant can further include a solvent. The sealant can optionally be pressurized with a propellant within a housing, such as an aerosol can. The sealant can be applied by spraying the sealant from the aerosol can on the portion of the air filter which includes the leak, or can be applied manually to the air filter. Curing can be facilitated by applying heat to the sealant, or by the application of air flow.

In accordance with an additional embodiment of the present invention, a method of sealing a leak in a portion of an air filter is provided. The method includes, but is not limited to, applying a sealant comprising a mixture of a micro fiber glass and a solvent to the portion of the air filter which includes the leak, and allowing the sealant to cure. Applying the sealant may be accomplished by manually applying the sealant to the portion of the air filter which includes the leak. Curing can be facilitated by applying heat to the sealant, or by the application of air flow.

### BRIEF DESCRIPTION OF THE DRAWINGS

The present invention will be more fully understood and appreciated by reading the following Detailed Description in conjunction with the accompanying drawings, in which:

FIGS. 1a-b are schematic views illustrating a cross section of an accordion style pleated air filter media common to HEPA and ULPA air filters, and conventional repairing or patching of air filter leaks;

FIGS. 2a-b are magnified (scanning electron microscope (“SEM”)) views illustrating the fibrous structure of air filter media and its multiple fiber layers; and

FIGS. 3a-c are schematic scanning electron microscope views illustrating a cross section of an accordion style pleated air filter media common to HEPA and ULPA air filters, a sealant for air filter leaks (such as HEPA and ULPA high efficiency air filters), and the sealant's method of application, in accordance with an embodiment of the present invention.

### DETAILED DESCRIPTION

Reference will now be made in detail to the present preferred embodiments of the invention, wherein like reference numerals refer to like components, examples of which are illustrated in the accompanying drawing.

In accordance with an embodiment of the present invention, the sealant comprises a mixture including, but not limited to, a micro fiber glass and a solvent. The sealant can optionally be pressurized with a propellant, as discussed further below, although other methods of application are possible.

The microfiber glass component can include, but is not limited to, borosilicate fibers similar to the composition and size of glass fibers used in most HEPA and ULPA filters (as should be appreciated by those skilled in the art), where the fibers typically range from about 80-1000 nm diameters and can be as long as 5 mm.

The primary fluid/solvent component for dispersing the micro fiber glass can be water, since glass fibers most readily disperse in low pH water. Since glass fibers typically used in filter media most readily disperse in cationic solvents, alternative solvents which are cationic or those that can be made cationic by addition of cationic materials, can also be used. These alternative solvents include, but are not limited to, solvents such as alcohol, mineral spirits with cationic additives, etc.

The propellant can comprise, but is not limited to, air or any non-highly flammable gas commonly used for aerosol spray cans including nitrogen or carbon dioxide.

The sealant mixture noted above can have a low concentration of fibers to permit ease of application. In accordance with a preferred embodiment of the present invention, the aqueous mixture used for making the sealant mixture generally has less than 10% fiber.

The sealant is prepared by creating a slurry of the micro fiber glass component (similar to those used in the air filter media), with a propellant. As shown in FIG. 3c (discussed further below) an aerosol can 200 is charged with this fiber and solvent mixture 210, and pressurized with the propellant such as a compressed gas 220 (air, nitrogen, etc.).

Turning to FIGS. 3a-c, a schematic face view of a cross section of an air filter (such as HEPA and ULPA high efficiency air filters), a sealant for air filter leaks, and the sealant's method of application are illustrated, in accordance with an embodiment of the present invention.

FIG. 3a is a schematic face view of a cross section of an air filter 10 illustrating accordion style pleated air filter media 100 common to HEPA and ULPA air filters.

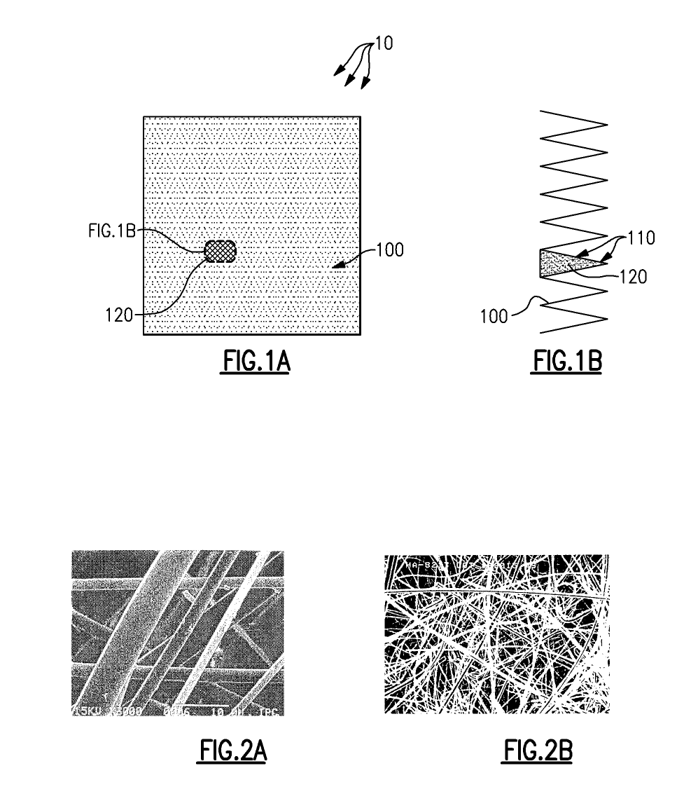

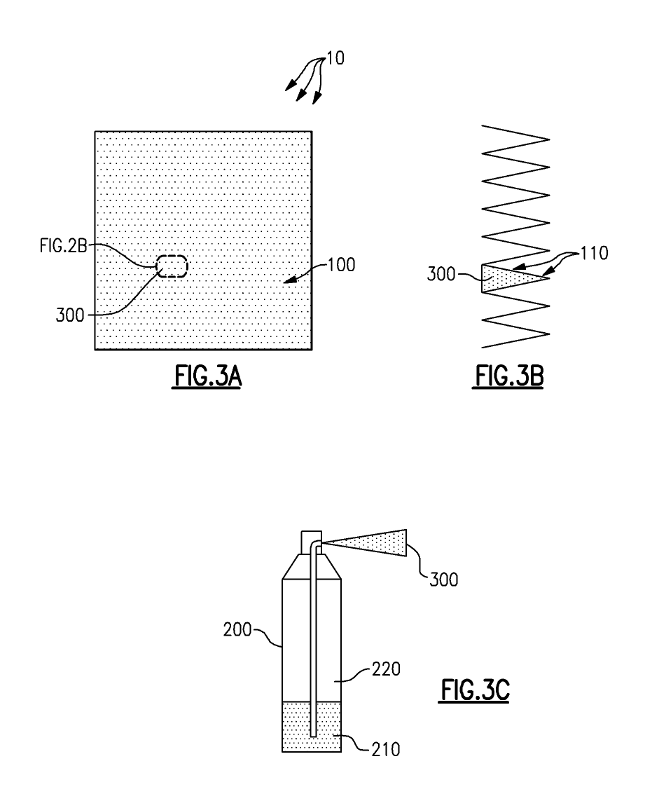

FIG. 3b is an expanded view of a portion (portion “A”) of the air filter 10 as shown in FIG. 3a. This portion illustrates a section which contains a suspected leak that needs to be patched, and is shown patched with the sealant mixture 210 as applied as a fine fiber spray 300 (shown lighter than 120 in FIG. 1b).

In accordance with an embodiment of the present invention, the sealing mixture may be applied two different ways. First, it can be applied by a pressurized aerosol can charged with propellant. FIG. 3c is a transparent view of the aerosol spray can 200 including the compressed gas propellant 220, and the sealant 210 (fiber and solvent mixture) for air filter leaks (such as HEPA and ULPA high efficiency air filters). Since the fibers are small enough, the aerosol can 200 is sufficient to provide a fine fiber spray 300 of the fibrous mixture 210. By directing this spray 300 at the leaks 110 in a filter, a fine layer of fibers will patch the leak 110 as shown in FIGS. 3b. When the sealant cures over time, the resultant patch can patch the leak with a porous sealant similar to the media with minimal or no blocking of the filter (see FIG. 3b), as compared with the current caulking technique shown in FIGS. 1a-b. In addition to a blockage free seal of the leak, the use of aerosol cans can be a more convenient and less cumbersome means for fixing leaks in the field.

One may also alter the rate of curing for the patch with or without heat. For example, in accordance with an embodiment with the present invention, once the repair sealant mixture 210 has been applied (e.g., as a spray), the resultant patch can be cured either by heat or by humidity or ambient air. Cross-linking and curing can be achieved by hot air guns. The heat will also evaporate any water associated with the mixture that is deposited on the filter. Where heat is not allowed for other operational reasons at the installation, other adhesives can be used. In this case, the moisture can be removed by normal air flow, albeit at a potentially slower rate.

In accordance with an alternative embodiment of the present invention, where a spray is not acceptable, the same fiber (with solvent but without propellant), may be brushed or otherwise manually applied over the leak 110 or the region of the leak for a similar blockage free sealing of leaks 100. This includes any known method or means of manual application, including using a brush, sponge, syringe, or squeeze bottle, pouring the slurry over the leak, or any other mechanism of non-propellant manual delivery. As with the spraying described above, the fibers may be applied as one mixture or separately.

While the invention is susceptible to various modifications, and alternative forms, specific examples thereof have been shown in the drawing and are herein described in detail. It should be understood, however, that the invention is not to be limited to the particular forms or methods disclosed, but to the contrary, the invention is to cover all modifications, equivalents and alternatives falling within the spirit and scope of the claimed invention.

### DEFINITIONS

The following definitions are provided to facilitate claim interpretation:

Present invention: means at least some embodiments of the present invention; references to various feature(s) of the “present invention” throughout this document do not mean that all claimed embodiments or methods include the referenced feature(s).

First, second, third, etc. (“ordinals”): Unless otherwise noted, ordinals only serve to distinguish or identify (e.g., various members of a group); the mere use of ordinals implies neither a consecutive numerical limit nor a serial limitation.

To the extent that the definitions provided above are consistent with ordinary, plain, and accustomed meanings (as generally shown by documents such as dictionaries and/or technical lexicons), the above definitions shall be considered supplemental in nature. To the extent that the definitions provided above are inconsistent with ordinary, plain, and accustomed meanings (as generally shown by documents such as dictionaries and/or technical lexicons), the above definitions shall control. If the definitions provided above are broader than the ordinary, plain, and accustomed meanings in some aspect, then the above definitions shall be considered to broaden the claim accordingly.

To the extent that a patentee may act as its own lexicographer under applicable law, it is hereby further directed that all words appearing in the claims section, except for the above-defined words, shall take on their ordinary, plain, and accustomed meanings (as generally shown by documents such as dictionaries and/or technical lexicons), and shall not be considered to be specially defined in this specification. In the situation where a word or term used in the claims has more than one alternative ordinary, plain and accustomed meaning, the broadest definition that is consistent with technological feasibility and not directly inconsistent with the specification shall control.

Unless otherwise explicitly provided in the claim language, steps in method steps or process claims need only be performed in the same time order as the order the steps are recited in the claim only to the extent that impossibility or extreme feasibility problems dictate that the recited step order (or portion of the recited step order) be used. This broad interpretation with respect to step order is to be used regardless of whether the alternative time ordering(s) of the claimed steps is particularly mentioned or discussed in this document.

What is claimed is:

1. A sealant comprising a mixture of:
a. a micro fiber glass; and
b. a solvent.

2. The sealant of claim 1, further comprising:
a propellant.

3. The sealant of claim 2, wherein said propellant is a compressed gas selected from the group consisting of nitrogen, air, or other non highly flammable gas.

4. The sealant of claim 2, wherein said mixture is pressurized within a housing.

5. The sealant of claim 1, wherein said solvent is selected from the group consisting of water, weak acid alcohol, and a mineral spirit.

6. The sealant of claim 1, wherein said micro fiber glass comprises borosilicate fibers.

7. The sealant of claim 1, wherein said mixture comprises less than 10% micro fiber glass.

8. The sealant of claim 4, wherein said housing is an aerosol can.

9. A method of sealing a leak in a portion of an air filter comprising the steps of:
a. applying a sealant comprising a mixture of a micro fiber glass and a solvent to the portion of the air filter which includes the leak; and
b. allowing said sealant to cure.

10. The method of claim 9, wherein said sealant further comprises a propellant.

11. The method of claim 10, wherein said propellant is a compressed gas selected from the group consisting of nitrogen, air, or other non highly flammable gas.

12. The method of claim 10, wherein said mixture is pressurized within a housing.

13. The method of claim 12, wherein said housing is an aerosol can.

14. The method of claim 9, wherein the step of applying further comprises the step of spraying said sealant from said aerosol can on the portion of the air filter which includes the leak.

15. The method of claim 11, wherein the step of allowing said sealant to cure further comprises the step of applying heat to said sealant.
